(19) United States
(12) Patent Application Publication
(10) Pub. No.: US 2009/0072106 A1
(43) Pub. Date: Mar. 19, 2009

(54) Universal mount

(76) Inventor: Edward Zheng, La Verne, CA (US)

Correspondence Address: DAVID AND RAYMOND PATENT FIRM, 108 N. YNEZ AVE., SUITE 128, MONTEREY PARK, CA, 91754, US

(21) Appl. No.: 12/231,881

(22) Filed: Sep. 4, 2008

Related U.S. Application Data
(60) Provisional application No. 60/967,439, filed on Sep. 4, 2007.

(51) Int. Cl. F16M 13/00

(52) U.S. Cl. 248/231.41

(57) ABSTRACT

A universal mount includes a supporting frame, a fin locker, and a device holder. The supporting frame includes a supporting arm, a locker arm transversely extended from the supporting arm towards a vent fin of an automobile, and an adjustable joint provided at the supporting arm. The fin locker is provided at the locker arm for releasably locking a free end of the locker arm at the vent fin. The device holder is rotatably coupling with the adjustable joint for detachably coupling with the portable device, wherein the device holder is adjusted a tilt angle with respect to the supporting frame for selectively adjusting an optimum position of the portable device with respect to a user.

### CROSS REFERENCE OF RELATED APPLICATION

This is a non-provisional application of a provisional application having an application No. 60/967,439 and a filing date of Sep. 4, 2007.

### BACKGROUND OF THE PRESENT INVENTION

1. Field of Invention

The present invention relates to a mount for an automobile, and more particularly to a portable universal mount which is securely mounted to the automotive vent fin for supporting a portable device such a GPS device, a music player or a cellular phone, wherein the driver is able to selectively adjust the tilt angle of the universal to set an optimum position of the portable device based on the user preference.

2. Description of Related Arts

Driving has become the most important and common activity for most people nowadays. Over the years, the technology involved in manufacturing an automobile has become more advanced, drivers shift their focus from basic transportation to the design of features that make a vehicle safer, more comfortable, and more easily operated.

The Global Positioning System (GPS) is more widely used recently and almost becomes an indispensable equipment to assist automobile driver to navigate and reach the destination place more easily by following the directions provided by the GPS. The GPS device is usually mounted on the windshield in front of the automobile driver by a plastic connector with two ends, one of which connects to the GPS device and the other sucks on the windshield. This configuration suffers from some limitations, for example, the plastic connector can be deformed or degraded over time and the surface tension between the windshield and the connector gradually diminishes to effectively hold the GPS device. More seriously, the GPS device may suddenly fall down when the surface tension is not enough to hold the GPS device and the GPS device is likely to be damaged as well as the dashboard of the automobile. Also, the GPS device is somewhat bulky on the windshield and may block the driver's vision of the traffic, and the GPS device on the windshield may be too far away from the driver to see or operate it.

The GPS device may be mounted on the dashboard of the automobile by using double-side adhesive. Likewise, the double-side adhesive may lose its adhesion capability over time and the GPS device may fall down suddenly as illustrated above. Also, even it is already closer to the driver when placing the GPS device on the dashboard, it is still a little far for the driver to effectively and conveniently operate or see it. Moreover, the double-side adhesive is likely to leave an irremovable mark on the dashboard which would significantly reduce the aesthetic value of the interior of the automobile.

The GPS device can also be mounted near the fins of the air conditioner by a clamping device, which may solve the problems that the GPS device may suddenly fall down and the driver is far away from the GPS device, but the clamping device with strong clamping force may damage the fins of the air conditioner. Furthermore, the GPS device may not be structurally stable based on the physics principle because in the entire system (including the clamping device and the GPS device) the force is only exerted at one place where the clamping device clamps the fins.

### SUMMARY OF THE PRESENT INVENTION

A main object of the present invention is to provide a universal mount for mounting a portable device at a vent fin of an automobile, wherein the portable device such as a GPS, a music player or a cellular phone can be mounted thereon within a hand-reachable distance for the driver while driving, such that the driver can see and operate the device more easily and effectively. In other words, the driver is able to selectively adjust the tilt angle of the universal to set an optimum position of the portable device based on the user preference.

Another object of the present invention is to provide a universal mount for mounting a portable device at a vent fin of an automobile, wherein the universal mount has a fin locker to securely lock up the universal mount at the vent fin in a tool-less manner. Accordingly, the universal mount is detachably mounted at the front and rear edges of the vent fin to provide a secure attachment.

Another object of the present invention is to provide a universal mount which provides a three-point point for the portable device to enhance the stabilization of the portable device.

Another object of the present invention is to provide a universal mount which can be folded into a compact size for storage and carriage.

Another object of the present invention is to provide a universal mount for mounting a portable device at a vent fin of an automobile, wherein the portable device such as a GPS, a music player or a cellular phone can be securely mounted thereon to avoid the problem that the portable device may fall off from the mounting device to damage the dashboard and the portable device itself.

Another object of the present invention is to provide a universal mount for mounting a portable device at a vent fin of an automobile, wherein the portable device such as a GPS, a music player or a cellular phone can be securely mounted thereon to avoid mounting on the dashboard by double-side adhesive which is likely to leave an irremovable mark thereon which would significantly reduce the aesthetic value of the interior of the automobile.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a universal mount for supporting a portable device at the automotive vent fin according to a preferred embodiment of the present invention.

FIG. 2 is a side view of the universal mount mounting at the automotive vent fin to support the portable device according to the above preferred embodiment of the present invention.

FIG. 3 is a side view of the locker arm locking at the vent fin via the fin locker according to the above preferred embodiment of the present invention.

FIG. 4 is a side view of the rotatable joint of the universal mount according to the above preferred embodiment of the present invention.

FIG. 5 is a sectional view of the device holder coupling with the adjustable joint according to the above preferred embodiment of the present invention.

FIG. 6 is a perspective view of the universal mount at the folded position according to the above preferred embodiment of the present invention.

### DETAILED DESCRIPTION OF THE PREFERRED EMBODIMENT

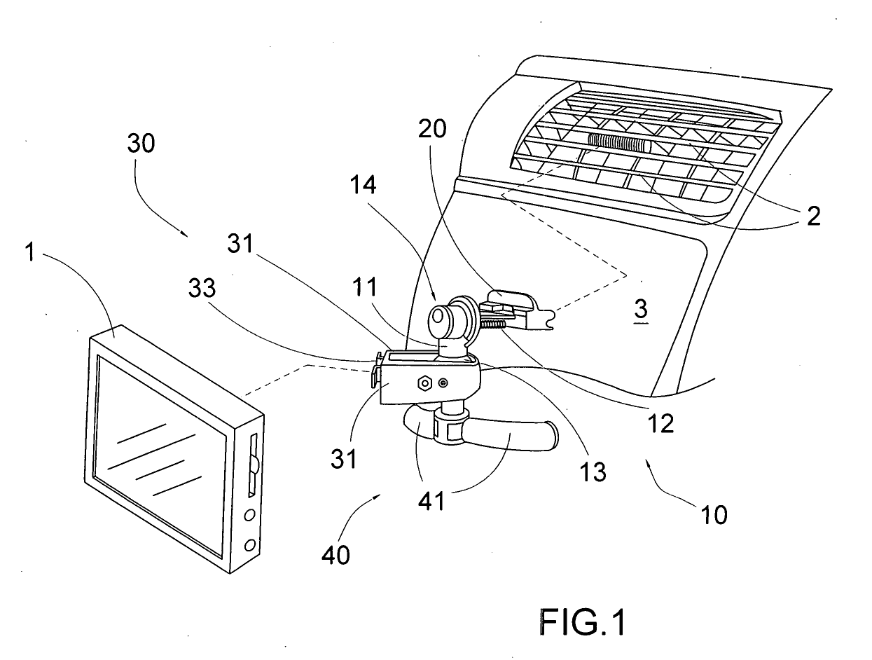

Referring to FIG. 1 of the drawings, a universal mount according to a preferred embodiment of the present invention is illustrated, wherein the universal mount is adapted for mounting a portable device 1 at a vent fin 2 of an automobile. Accordingly, the universal mount comprises a supporting frame 10, a fin locker 20, a device holder 30, and a retention frame 40.

The supporting frame 10 comprises a supporting arm 11, a locker arm 12 transversely extended from the supporting arm towards the vent fin 2 of the automobile, and an adjustable joint 13 provided at the supporting arm 11.

According to the preferred embodiment, the supporting arm 11 has an elongated structure and defines two end portions that the locker arm 12 and the retention frame 40 are extended at the two end portions of the supporting arm 11 respectively, wherein the adjustable joint 13 is provided at the supporting arm 11 between the two end portions thereof.

The locker arm 12 has a planar structure adapted for slidably passing through a gap between two vent fins 1 to engage with one of the vent fins 1. Accordingly, the free end of the locker arm 12 forms a hooking end 121 for engaging with a rear edge of the vent fin 2.

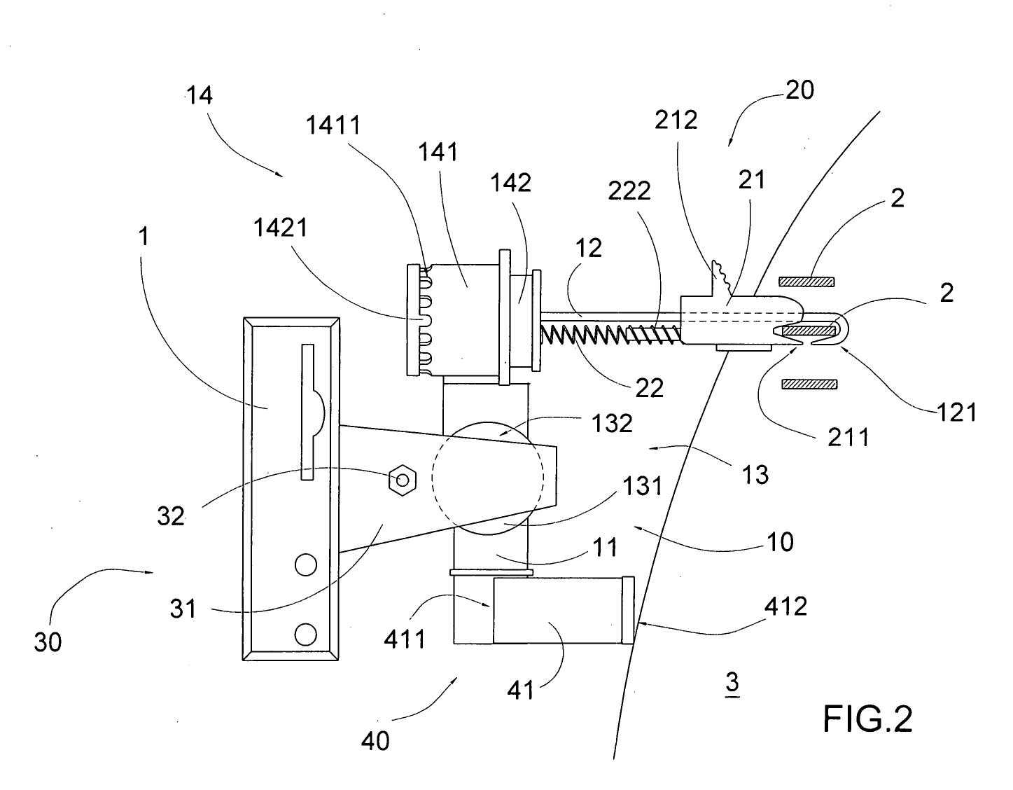

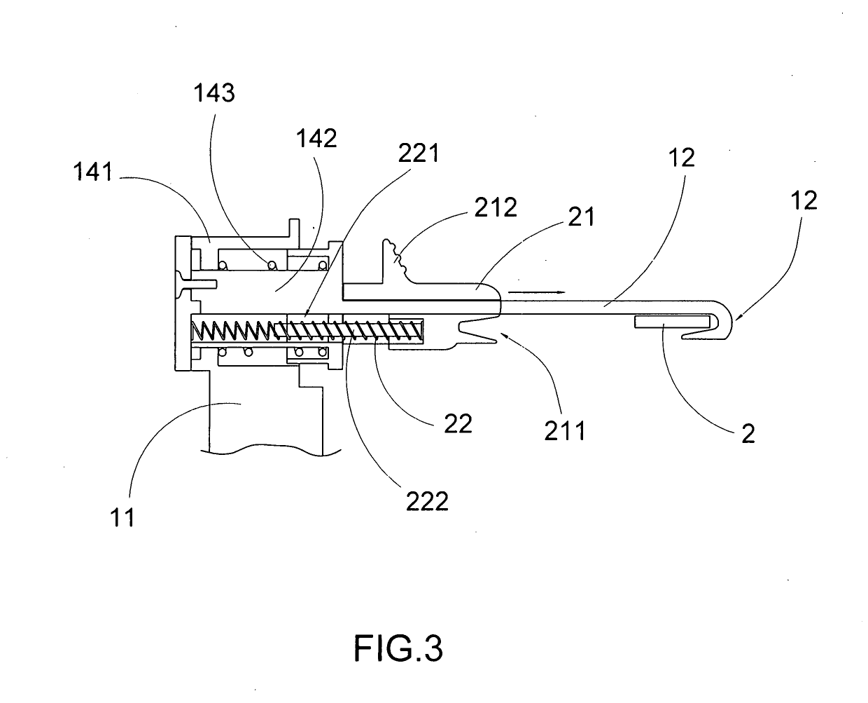

As shown in FIGS. 2 and 3, the fin locker 20 is provided at the locker arm 12 for releasably locking the free end of the locker arm 12 at the vent fin 2. The fin locker 20 comprises a pusher lock 21 slidably mounted at the locker arm 12 and a resilient element 22 supported at the locker arm 12 for applying an urging force against the pusher lock 21 towards the free end of the locker arm 12 so as to lock up the free end of the locker arm 12 at the vent fin 2.

Accordingly, when the free end of the locker arm 12 is engaged with the rear edge of the vent fin 2, the pusher lock 21 is pushed by the resilient element 22 to bias against the front edge of the vent fin 2 such that the locker arm 12 is locked at the vent fin 2 at the front and rear edges of the vent fin 2.

More specifically, the pusher lock 21 has a fin slot 211 facing towards the free end of the locker arm 12 for engaging with the front edge of the vent fin 2, and an actuation portion 212 driving the pusher lock 21 to slide along the locker arm 12 for releasing the fin slot 211 from the vent fin 2.

Accordingly, the fin slot 211 has a general U-shaped structure and has a width larger than a thickness of the vent fin 2 such that when the pusher lock 21 is pushed to the vent fin 2, the front edge of the vent fin 2 is engaged with the fin slot 211 of the pusher lock 21. It is worth to mention that the rear edge of the vent fin 2 is engaged with the hooking end 121 (free end) of the locker arm 12 and the front edge of the vent fin 2 is engaged with the fin slot 211 of the pusher lock 21 such that when the universal mount of the present invention is mounted at the vent fin 2, the universal mount will be stably held in position to prevent any unwanted lateral movement thereof to retain the portable device.

The resilient element 22, according to the preferred embodiment, comprises a compression spring having two ends biasing against the rear wall of the locker arm 12 and the pusher lock 21 respectively to push the pusher lock 21 towards the free end of the locker arm 12. In other words, the resilient element 22 normally applies a pushing force against the pusher lock 21 to the free end of the locker arm 12 so as to retain the lock up position of the locker arm 12 to the vent fin 2.

The resilient element 22 is supported underneath the locker arm 12 via a spring holder. Accordingly, the spring holder 22 contains a spring hole 221 is provided at the rear wall of the locker arm 12 and comprises a spring arm 222 is extended from the pusher lock 21 to align with the spring hole, wherein one end of the resilient element 22 is received in the spring hole 221 while the spring arm 222 is slidably and coaxially inserted into another opposed end of the resilient element 22 so as to hold the resilient element 22 in position.

The actuation portion 212 of the pusher lock 21 is arranged for the user to slidably move the pusher lock 21 along the locker arm 12, wherein when the pusher locker 21 is slid away from the free end of the locker arm 12, the fin slot 211 of the pusher locker 21 is disengaged with the front edge of the vent fin 2 for detaching the locker arm 12 from the vent fin 2. In other words, the universal mount of the present invention does not require any tool to mount at the vent fin 2. In addition, the mounting operation is extremely simple by hooking the free end of the locker arm 12 at the rear edge of the vent fin 2 and engaging the fin slot 211 of the pusher locker 21 with the front edge of the vent fin 2. The detaching operation is also extremely simple by pulling the pusher lock 21 away from the free end of the locker arm 12 until the fin slot 211 of the pusher locker 21 is disengaged with the front edge of the vent fin 2. Therefore, the universal mount of the present invention requires tool-less and is hassle free to mount at and detach from the vent fin 2.

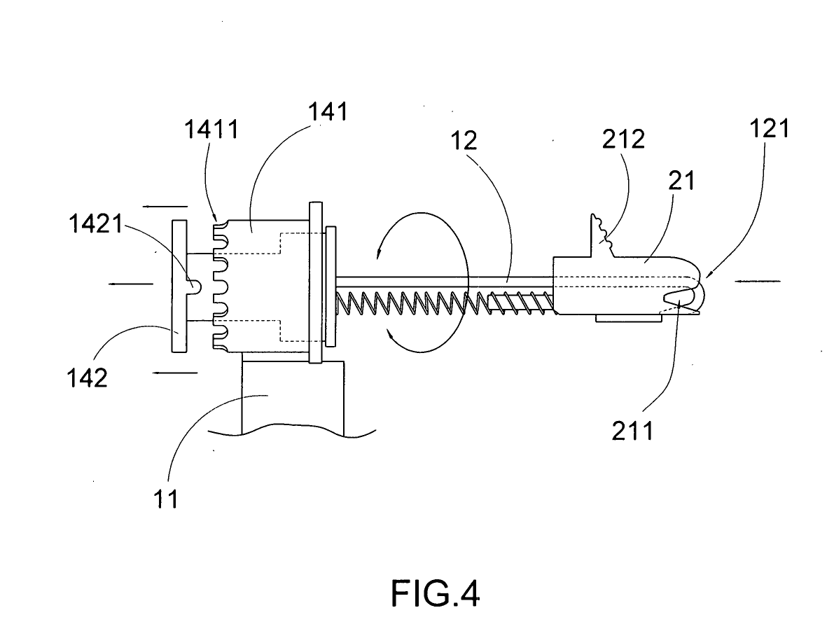

As shown in FIGS. 2 to 4, the supporting frame 10 further comprises a rotatable joint 14 provided at the supporting arm 11 to rotatably coupling with the locker arm 12, such that the locker arm 12 is selectively rotated to adjust an angular position thereof for locking at the vent fin 2. It is worth to mention that different automobiles design with different vent fin configurations. Some automobiles have the horizontal vent configuration that the vent fins 1 are horizontally supported at the air outlet. Some automobiles have the vertical vent fin configuration that the vent fins 1 are vertically supported at the air outlet. Some automobiles have the rotatable vent configuration that the vent structure can be rotated to selectively adjust the vent fins 1 at a slanted position. The rotatable joint 14 is allowed to self-adjust the position of the locker arm 12 to match with different vent configurations to fit the universal mount to the vent fin 2.

Accordingly, the rotatable joint 14 comprises a tubular sleeve 141 integrally extended from the supporting arm 11 and a locker slider 142 integrally extended from the locker arm 12 to slidably engage with the tubular sleeve 141 in a free rotation manner. Therefore, the locker arm 12 is free to rotate about the tubular sleeve 141 to adjust the angular position of the locker arm 12 with respect to the supporting arm 11.

In order to lock up the rotational movement of the locker arm 12, the rotatable joint 14 further comprises a resilient unit 143 disposed in the tubular sleeve 141 for applying a biasing force against the locking slider 142. According to the preferred embodiment, the tubular sleeve 141 has a teething circumferential edge 1411 at an edge portion. The locking slider 142 has at least a locker tip 1421 protruded to engage with the teething circumferential edge 1411 of the tubular sleeve 141.

As shown in FIG. 3, the resilient unit 143, which is embodied as a compression spring, having two ends biasing against the tubular sleeve 141 and the locking slider 142 respectively to retain the locker tip 1421 of the locking slider 142 engaging with the teething circumferential edge 1411 of the tubular sleeve 141 so as to lock up the rotation movement of the locker slider 142. In other words, for adjusting the angular position of the locker arm 12, the locker arm 12 must be firstly pushed to drive the locking slider 142 to slide within the tubular sleeve 141 until the locker tip 1421 of the locking slider 142 disengages with the teething circumferential edge 1411 of the tubular sleeve 141. Then, the locker arm 12 can be freely rotated to adjust the angular position thereof. Once the angular position of the locker arm 12 is set, the user is able to release the pushing force against the locker arm 12. Therefore, the compressed resilient unit 143 will push the locking slider 142 back to its original position to re-engage the locker tip 1421 of the locking slider 142 with the teething circumferential edge 1411 of the tubular sleeve 141.

According to the preferred embodiment, the device holder 30 is rotatably coupling with the adjustable joint 13 for detachably coupling with the portable device 1, wherein the device holder 30 is adjusted a tilt angle with respect to the supporting frame 10 for selectively adjusting an optimum position of the portable device 1 with respect to a user. Since the portable device 1 is mounted at the vent fin 2 of the automobile via the universal mount of the present invention, the user, especially the driver, is able to reach the portable device 1 and to selectively adjust the orientation of the portable device 1 corresponding to the user reference.

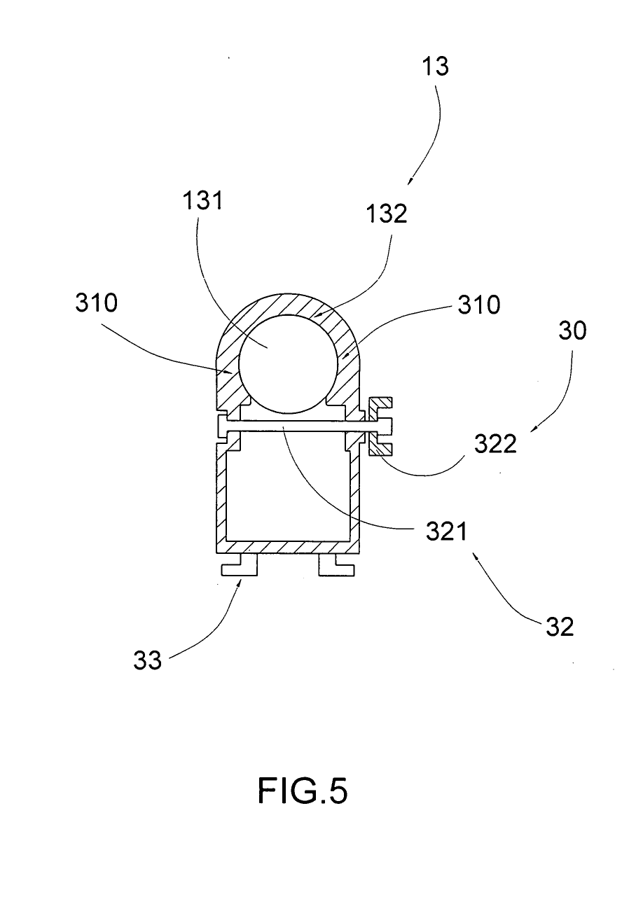

As shown in FIG. 5, the adjustable joint 13 comprises a ball joint 131, which is integrally provided at the supporting arm 11, having a spherical engaging surface 132 to engage with the device holder 30 such that the device holder 30 is adjustably turned at the engaging surface 132 of the ball joint 131 to selectively adjust the tilt angle of the device holder 30.

The device holder 30 comprises a U-shaped holding frame 31 having two spaced apart inner concave surfaces 310 engaging with the engaging surface 132 of the ball joint 131, a position lock 32 coupling with the holding frame 31 to releasably lock up the concave surfaces 310 of the holding frame 31 at the engaging surface 132 of the ball joint 131 in an immovable manner, and an adapter 33 provided at the holding frame 31 for detachably engaging with the portable device 1 in position.

As shown in FIG. 5, the holding frame 31 has a cornering portion defining the two inner concave surfaces 310 thereat, wherein the cornering portion of the holding frame 31 has a curvature matching with the curvature of the engaging surface 132 of the ball joint 131. The holding frame 31 further has two straight portions integrally extended from the cornering portion. Accordingly, the inner concave surfaces 310 of the holding frame 31 is frictionally engaged with the engaging surface 132 of the ball joint 131 such that the holding frame 31 is adapted to freely turn around the ball joint 131 to adjust the tilt angle of the device holder 30.

The distance between the straight portions of the holding frame 31 play an important role in frictionally lock up the movement of the holding frame 31. When the distance between the straight portions of the holding frame 31 is slightly increased, a clearance between the inner concave surfaces 310 of the holding frame 31 and the engaging surface 132 of the ball joint 131 is formed. The clearance will let the free rotational movement of the holding frame 31. When the distance between the straight portions of the holding frame 31 is slightly reduced, the inner concave surfaces 310 of the holding frame 31 will frictionally engage with the engaging surface 132 of the ball joint 131 to lock up the holding frame 31 at the supporting arm via the adjustable joint 13.

According to the preferred embodiment, the position lock 32 is arranged to adjust the distance between the straight portions of the holding frame 31 to lock up the holding frame 31. The position lock 31 comprises a locking shaft 321 having an affixing end affixed to one of the straight portions of the holding frame 31 and an opposed control end extended through another straight portion of the holding frame 31, and a control knob 322 rotatably coupling with the control end of the locking shaft 321 in such a manner that when the control knob 322 is rotated at one direction, the distance between the straight portions of the holding frame 31 is slightly reduced, and when the control knob 322 is rotated at an opposed direction, the distance between the straight portions of the holding frame 31 is slightly increased. It is worth to mention that the locking shaft 321 is extended between the straight portions of the holding frame 31 at a position close to the ball joint 131.

The adapter 33 is integrally formed between two ends of the straight portions of the holding frame 31 wherein the adapter 33 is arranged to detachably couple with the portable device 1 so as to mount the portable device 1 at the supporting frame 10 via the device holder 30. The engagement between the adapter 33 and the portable device 1 can be directly mount the adapter 33 to the portable device 1 especially when the portable device 1 is a portable GPS device, or can be incorporated with a carrier mounting to the adapter 33 to hold the portable device 1 in position especially the portable device 1 is a portable music player or a cellular phone. It is worth to mention that the portable device 1 can be selectively adjusted the tilt angle that the screen and/or control panel of the portable device 1 is facing towards the user.

If the portable device 1 is relatively heavy, the vent fin 2 may not be strong enough to support the portable device 1 by locking the locker arm 12 at the vent fin 2. According to the preferred embodiment, the retention frame 40 is transversely extended from the supporting arm 11 apart from the locker arm 12, wherein the retention frame 40 is extended rearwardly for biasing against a dashboard surface 3 of the automobile when the locker arm 12 is locked at the vent fin 2 to substantially support the portable device 1 in position. Accordingly, when the retention frame 40 is biased against the dashboard surface 3 of the automobile, the weight of the portable device 1 can be substantially distributed to the dashboard so as to minimize the stress created at the vent fin 2.

The retention frame 40 comprises two pivot arms 41 to bias against the dashboard surface 3 of the automobile. Accordingly, each of the pivot arms 41 has a pivot end 411 pivotally coupling with the supporting arm 11 and a biasing end 412 arranged in such a manner that when the two pivot arms 41 are outwardly and pivotally folded from the supporting arm 11, the biasing ends 412 of the pivot arms 411 are substantially biased against the dashboard surface 3 to form a three-point support for the portable device 1 when the locker arm 12 is locked at the vent fin 2.

Each of the pivot arms 41 has a predetermined curvature that when the pivot arms 41 are outwardly and pivotally folded from the supporting arm 11, the biasing ends 412 of the pivot arms 41 are adapted to bias against the dashboard surface 3 of the automobile. In other words, when the pivot arms 41 are pivotally folded towards each other, the distance between the biasing ends 412 of the pivot arms 41 is minimized. When the pivot arms 41 are pivotally folded away from each other, the distance between the biasing ends 412 of the pivot arms 41 is maximized. Therefore, the universal mount of the present invention provides the three-point support, including the free end of the locker arm 12 at the vent fin 2 and the biasing ends 412 of the pivot arms 41 at the dashboard surface 3, to rigidly support the portable device 1. It is worth to mention that the maximum distance between the biasing ends 412 of the pivot arms 41 also enhances the stabilization of the portable device 1 to prevent the unwanted movement of the portable device 1 through the vibration of the automobile. In other words, during driving, the portable device 1 can be securely held at the vent fin 2 and stably supported by the dashboard 1 that the driver is able to view and operate the portable device 1 within the hand reachable distance.

The mounting operation of the universal mount of the present invention is extremely easy in tool-less manner. In order to mount the portable device 1 at the vent fin 2, the user is able pull the actuation portion 212 of the pusher lock 21 to slide the pusher locker 21 along the locker arm 12 and away from the free end of the locker arm 12. Then, the locker arm 12 is slid between two vent fins 2 until the hooking end 121 (the free end) of the locker arm 12 is engaged with the rear edge of the corresponding vent fin 2. By releasing the pulling force at the actuation portion 212 of the pusher lock 21, the pusher lock 21 is pushed by the resilient element 22 towards the free end of the locker arm 12 until the fin slot 211 of the pusher lock 21 is engaged with the front edge of the vent fin 2. By outwardly folding the two pivot arms 41, the biasing ends 412 of the pivot arms 41 are substantially biased against the dashboard surface 3 to form the three-point support to rigidly support the portable device 1. In order to adjust the tilt angle of the portable device 1, the user is able to rotate the control knob 322 to let the free rotational movement of the holding frame 31. Once the tilt angle of the portable device 1 is set corresponding to the user reference, the control knob 322 is rotated back to lock up the holding frame 31 with the supporting frame 10 so as to retain the portable device 1 at the tilt angle.

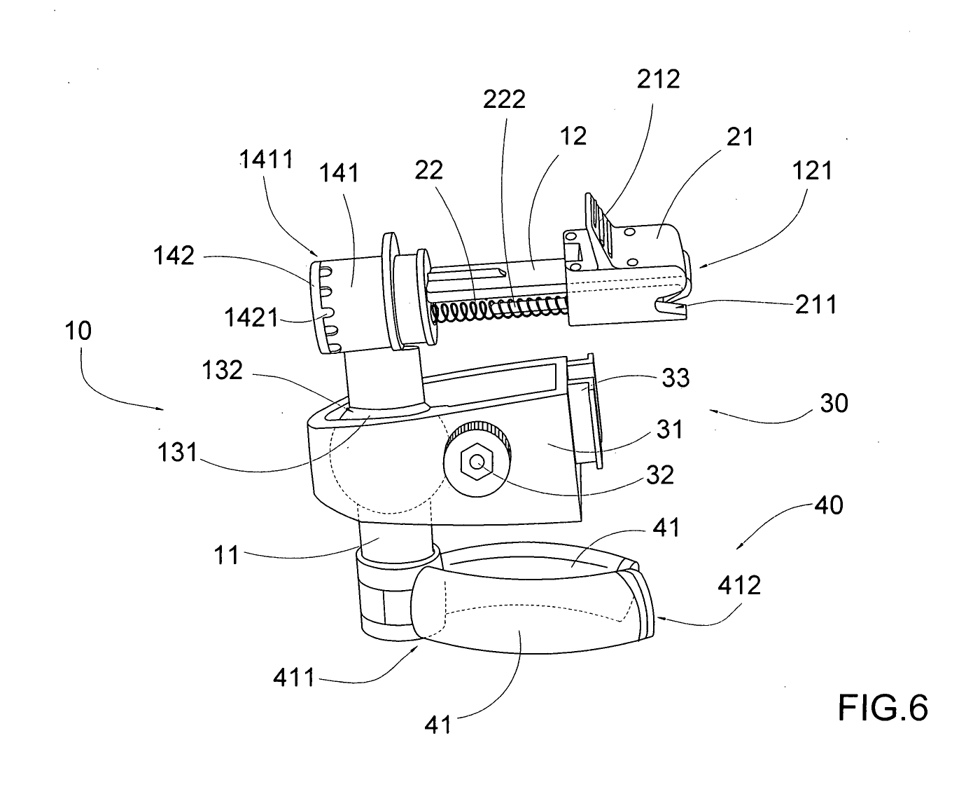

It is worth to mention that the universal mount of the present invention is relatively small in size and light weight to enhance the portability of the universal mount. Accordingly, the device holder 30 can be turned via the adjustable joint 13 at a position between the locker arm 12 and the retention frame 41 to minimize the overall size of the universal mount for easy carriage and storage, as shown in FIG. 6. Therefore, the user is able to put the universal mount in his/her pocket and carry the universal mount from one automobile to another automobile.

For usage, the user is able to turn the device holder 30 via the adjustable joint 13 at the direction opposite to the locker arm 12, as shown in FIG. 1, to mount the portable device 1. With the lengths of the locker arm 12 and the pivot arms 41, the supporting arm 11 is supported away from the vent fin 2 such that the air exiting from the air outlet will not be blocked by the universal mount. When the AC of the automobile is switched on, the cool air exiting at the air outlet can cool down the portable device 1 as well.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A universal mount for mounting a portable device at a vent fin of an automobile, comprising:
a supporting frame comprising a supporting arm, a locker arm transversely extended from said supporting aim towards said vent fin of said automobile, and an adjustable joint provided at said supporting arm;
a fin locker provided at said locker arm for releasably locking a free end of said locker arm at said vent fin; and
a device holder rotatably coupling with said adjustable joint for detachably coupling with said portable device, wherein said device holder is adjusted a tilt angle with respect to said supporting frame for selectively adjusting an optimum position of said portable device with respect to a user.

2. The universal mount, as recited in claim 1, wherein said free end of said locker arm forms a hooking end for engaging with a rear edge of said vent fin.

3. The universal mount, as recited in claim 1, wherein said fin locker comprises a pusher lock slidably mounted at said locker arm and a resilient element supported at said locker arm for applying an urging force against said pusher lock towards said free end of said locker arm so as to lock up said free end of said locker arm at said vent fin.

4. The universal mount, as recited in claim 2, wherein said fin locker comprises a pusher lock slidably mounted at said locker arm and a resilient element supported at said locker arm for applying an urging force against said pusher lock towards said free end of said locker arm so as to lock up said free end of said locker arm at said vent fin.

5. The universal mount, as recited in claim 4, wherein said pusher lock has a fin slot facing towards said free end of said locker arm for engaging with a front edge of said vent fin, and an actuation portion driving said pusher lock to slide along said locker arm for releasing said fin slot from said vent fin.

6. The universal mount, as recited in claim 4, wherein said pusher lock has a fin slot facing towards said free end of said locker arm for engaging with a front edge of said vent fin, and an actuation portion driving said pusher lock to slide along said locker arm for releasing said fin slot from said vent fin.

7. The universal mount, as recited in claim 1, wherein said adjustable joint comprises a ball joint, which is integrally provided at said supporting arm, having a spherical engaging surface to engage with said device holder such that said device holder is adjustably turned at said engaging surface of said ball joint to selectively adjust said tilt angle of said device holder.

8. The universal mount, as recited in claim 3, wherein said adjustable joint comprises a ball joint, which is integrally provided at said supporting arm, having a spherical engaging surface to engage with said device holder such that said device holder is adjustably turned at said engaging surface of said ball joint to selectively adjust said tilt angle of said device holder.

9. The universal mount, as recited in claim 6, wherein said adjustable joint comprises a ball joint, which is integrally provided at said supporting arm, having a spherical engaging surface to engage with said device holder such that said device holder is adjustably turned at said engaging surface of said ball joint to selectively adjust said tilt angle of said device holder.

10. The universal mount, as recited in claim 7, wherein said device holder comprises a U-shaped holding frame having two spaced apart inner concave surfaces engaging with said engaging surface of said ball joint, a position lock coupling with said holding frame to releasably lock up said concave surfaces of said holding frame at said engaging surface of said ball joint in an immovable manner, and an adapter provided at said holding frame for detachably engaging with said portable device in position.

11. The universal mount, as recited in claim 8, wherein said device holder comprises a U-shaped holding frame having two spaced apart inner concave surfaces engaging with said engaging surface of said ball joint, a position lock coupling with said holding frame to releasably lock up said concave surfaces of said holding frame at said engaging surface of said ball joint in an immovable manner, and an adapter provided at said holding frame for detachably engaging with said portable device in position.

12. The universal mount, as recited in claim 9, wherein said device holder comprises a U-shaped holding frame having two spaced apart inner concave surfaces engaging with said engaging surface of said ball joint, a position lock coupling with said holding frame to releasably lock up said concave surfaces of said holding frame at said engaging surface of said ball joint in an immovable manner, and an adapter provided at said holding frame for detachably engaging with said portable device in position.

13. The universal mount, as recited in claim 1, further comprising a retention frame transversely extended from said supporting arm apart from said locker arm, wherein said retention frame is extended rearwardly for biasing against a dashboard surface of said automobile when said locker arm is locked at said vent fin to substantially support said portable device in position.

14. The universal mount, as recited in claim 4, further comprising a retention frame transversely extended from said supporting arm apart from said locker arm, wherein said retention frame is extended rearwardly for biasing against a dashboard surface of said automobile when said locker arm is locked at said vent fin to substantially support said portable device in position.

15. The universal mount, as recited in claim 12, further comprising a retention frame transversely extended from said supporting arm apart from said locker arm, wherein said retention frame is extended rearwardly for biasing against a dashboard surface of said automobile when said locker arm is locked at said vent fin to substantially support said portable device in position.

16. The universal mount, as recited in claim 13, wherein said retention frame comprises two pivot arms, wherein each of said pivot arms has a pivot end pivotally coupling with said supporting arm and a biasing end arranged in such a manner that when said two pivot arms are outwardly and pivotally folded from said supporting arm, said biasing ends of said pivot arms are substantially biased against said dashboard surface to form a three-point support for said portable device when said locker arm is locked at said vent fin.

17. The universal mount, as recited in claim 14, wherein said retention frame comprises two pivot arms, wherein each of said pivot arms has a pivot end pivotally coupling with said supporting arm and a biasing end arranged in such a manner that when said two pivot arms are outwardly and pivotally folded from said supporting arm, said biasing ends of said pivot arms are substantially biased against said dashboard surface to form a three-point support for said portable device when said locker arm is locked at said vent fin.

18. The universal mount, as recited in claim 15, wherein said retention frame comprises two pivot arms, wherein each of said pivot arms has a pivot end pivotally coupling with said supporting arm and a biasing end arranged in such a manner that when said two pivot arms are outwardly and pivotally folded from said supporting arm, said biasing ends of said pivot arms are substantially biased against said dashboard surface to form a three-point support for said portable device when said locker arm is locked at said vent fin.

19. The universal mount, as recited in claim 13, wherein said locker arm and said retention frame are extended at two end portions of said supporting arm respectively, while said adjustable joint is provided at said supporting arm between said two end portions thereof.

20. The universal mount, as recited in claim 15, wherein said locker arm and said retention frame are extended at two end portions of said supporting arm respectively, while said adjustable joint is provided at said supporting arm between said two end portions thereof.

21. The universal mount, as recited in claim 18, wherein said locker arm and said retention frame are extended at two end portions of said supporting arm respectively, while said adjustable joint is provided at said supporting arm between said two end portions thereof.

22. The universal mount, as recited in claim 1, wherein said supporting frame further comprises a rotatable joint provided at said supporting arm to rotatably coupling with said locker arm, such that said locker arm is selectively rotated to adjust an angular position thereof for locking at said vent fin.

23. The universal mount, as recited in claim 4, wherein said supporting frame further comprises a rotatable joint provided at said supporting arm to rotatably coupling with said locker arm, such that said locker arm is selectively rotated to adjust an angular position thereof for locking at said vent fin.

24. The universal mount, as recited in claim 21, wherein said supporting frame further comprises a rotatable joint provided at said supporting arm to rotatably coupling with said locker arm, such that said locker arm is selectively rotated to adjust an angular position thereof for locking at said vent fin.

25. The universal mount, as recited in claim 22, wherein said rotatably joint comprises a tubular sleeve, having a teething circumferential edge, integrally formed at said supporting arm, a locking slider integrally extended from said locker arm to slidably engage with said tubular sleeve in a free rotation manner, and a resilient unit disposed in said tubular sleeve for applying a biasing force against said locking slider to retain said locking slider engaging with said teething circumferential edge of said tubular sleeve so as to lock up a rotation movement of said locker slider.

26. The universal mount, as recited in claim 23, wherein said rotatably joint comprises a tubular sleeve, having a teething circumferential edge, integrally formed at said supporting arm, a locking slider integrally extended from said locker arm to slidably engage with said tubular sleeve in a free rotation manner, and a resilient unit disposed in said tubular sleeve for applying a biasing force against said locking slider to retain said locking slider engaging with said teething circumferential edge of said tubular sleeve so as to lock up a rotation movement of said locker slider.

27. The universal mount, as recited in claim 24, wherein said rotatably joint comprises a tubular sleeve, having a teething circumferential edge, integrally formed at said supporting arm, a locking slider integrally extended from said locker arm to slidably engage with said tubular sleeve in a free rotation manner, and a resilient unit disposed in said tubular sleeve for applying a biasing force against said locking slider to retain said locking slider engaging with said teething circumferential edge of said tubular sleeve so as to lock up a rotation movement of said locker slider.
